(19) United States
(12) Patent Application Publication
(10) Pub. No.: US 2013/0124719 A1
(43) Pub. Date: May 16, 2013

(54) DETERMINING A BANDWIDTH THROUGHPUT REQUIREMENT

(71) Applicant: Gerardo M. Espinosa, McKinney, TX (US)

(72) Inventor: Gerardo M. Espinosa, McKinney, TX (US)

(73) Assignee: ALCATEL-LUCENT USA INC., Murray Hill, NJ (US)

(21) Appl. No.: 13/297,449

(22) Filed: Nov. 16, 2011

(51) Int. Cl. G06F 15/173

(52) U.S. Cl. 709/224

(57) ABSTRACT

Determining whether an adjustment in the bandwidth allocated to a particular network is appropriate may include polling a bandwidth usage of a device operating on a network over a fixed time interval of time by an application installed on network device, determining whether a current allocated bandwidth level allocated to the network satisfies the polled bandwidth usage, and requesting additional bandwidth from a bandwidth service provider upon determining that the current allocated bandwidth level does not satisfy the polled bandwidth usage.

### TECHNICAL FIELD

Disclosed are a method, apparatus and non-transitory computer readable storage medium of determining bandwidth throughput requirements at a customer premises by monitoring the actual bandwidth usage and requirements via a residential gateway and/or network access device (NAD).

### BACKGROUND

Conventionally, a residential gateway or network access device (NAD) establishes a connection to the Internet 100 and provides data services to various different devices wirelessly or through a wired connection. The residential service model has conventionally offered few options regarding variable bandwidth throughput levels. Back when such home-based data services began, most users were limited to one particular bandwidth level. In recent years, the bandwidth level provided to the end users may be increased. However, users are normally encouraged to purchase larger bandwidth packages from their Internet service providers (ISPs), which offer limited flexibility data service options.

The end users utilizing such data services are generally not setup to audit the actual amount of bandwidth needed per application or device. Applications which monitor and display the actual bandwidth required by home devices, broken down by individual devices and/or applications fail to provide the type of feedback required to make changes to a user's current throughput or bandwidth data rate. For example, home users would have to obtain software applications (i.e., sniffer tools) and manually monitor ‘current’ traffic and bandwidth usage of devices and applications in order to realize their bandwidth needs and requirements at any given time. Performing a data usage analysis process across multiple devices may produce certain values, which only reflect current bandwidth consumption rather than specific application requirements (i.e., the application may require less actual throughput but is currently operating at a peak usage time).

The lack of feedback by the residential gateway (RG) or network access device (NAD) creates limitations for the residential home users accessing such data services. There is also a lack of user capabilities to compare current home throughput demand against maximum access capacity based on a specific data service tier assigned to the home. Other inabilities experienced by the user of home data services include a lack of user capability to monitor and analyze the data service tier characteristics and actual maximum data rates. Such inabilities may occur in situations where a present operating condition has changed by including additional or fewer network computing devices. Also, the present operating condition may change based on the number or types of applications being used requiring additional bandwidth that the user's existing data service tier cannot honor.

### SUMMARY

One example embodiment may provide a method including polling a bandwidth usage of at least one device operating on a network over a fixed time interval by an application installed on at least one of a network access device and at least one device. The method may also include determining whether a current allocated bandwidth level allocated to the network satisfies the polled bandwidth usage, and requesting additional bandwidth from a bandwidth service provider upon determining that the current allocated bandwidth level does not satisfy the polled bandwidth usage.

Another example embodiment may include an apparatus including a processor configured to poll a bandwidth usage of at least one device operating on a network over a fixed time interval by an application installed on at least one of a network access device and at least one device. The processor may also determine whether a current allocated bandwidth level allocated to the network satisfies the polled bandwidth usage. The apparatus may further include a transmitter configured to transmit a request for additional bandwidth from a bandwidth service provider upon determining that the current allocated bandwidth level does not satisfy the polled bandwidth usage.

### BRIEF DESCRIPTION OF THE DRAWINGS

FIG. 1 illustrates an example access link configuration according to an example embodiment.

FIG. 2A illustrates a data flow exchange between the NAD and the network service provider according to another example embodiment.

FIG. 2B illustrates a data bandwidth computation protocol being implemented on a residential gateway configuration according to another example embodiment.

FIG. 3 illustrates an example network entity device configured to store instructions, software, and including corresponding hardware for performing various operations, according to example embodiments.

FIG. 4 illustrates a flow diagram of an example method of operation, according to example embodiments.

### DETAILED DESCRIPTION

It will be readily understood that the components of the example embodiments, as generally described and illustrated in the figures herein, may be arranged and designed in a wide variety of different configurations. Thus, the following detailed description of the embodiments of a method, apparatus, and system, as represented in the attached figures, is not intended to limit the scope of the embodiments as claimed, but is merely representative of selected embodiments.

The features, structures, or characteristics of the embodiments described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present disclosure. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present disclosure, the embodiments may be applied to many types of network data, such as, packet, frame, datagram, etc. For purposes of this disclosure, the term “message” also includes packet, frame, datagram, and any equivalents thereof. Furthermore, while certain types of messages and signaling are depicted in exemplary embodiments, the embodiments are not limited to a certain type of message, and are not limited to a certain type of signaling.

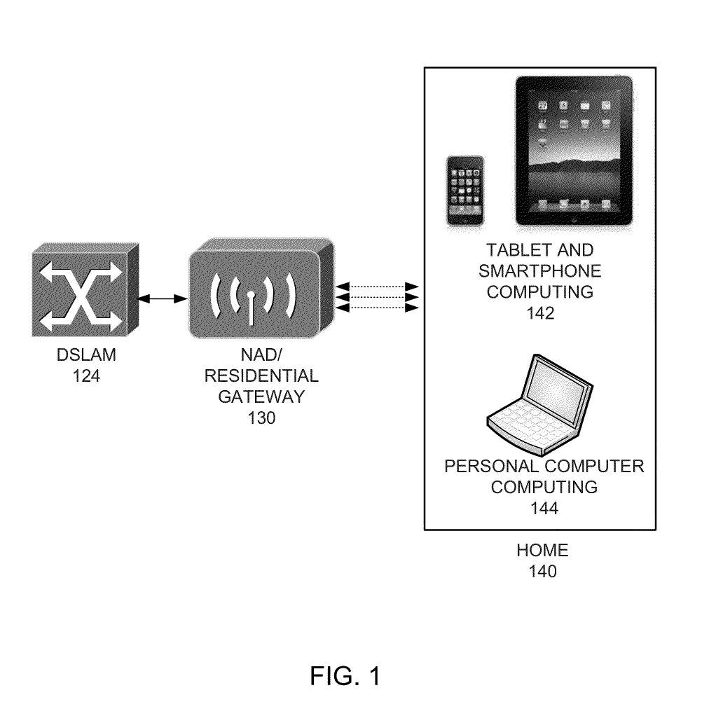

FIG. 1 illustrates an example communication network according to example embodiments. Referring to FIG. 1, a home network 140 may include various computing devices (e.g., smartphone, mobile station, tablet computing device, laptop computer, personal computer, set-top-boxes (STB), gaming devices—PS3®, XBOX®, etc.). The computing devices may be configured to communicate with a network access device (NAD) and/or a residential gateway (RG) device 130 via a wired or wireless communication link. In this example, a tablet/smartphone computing device 142 is illustrated as well as a laptop/personal computing device 144. All data traffic from the home devices 142 and 144 aggregates at the home residential gateway (RG) or NAD 130.

The NAD 130 acts as a single static routing point between the home devices 142 and 144 and the Internet domain. The NAD 130 performs traffic marking, prioritization, buffering and queuing of data. According to one example operation, the network service provider assigns an upstream/downstream bandwidth tier to a home subscriber 140. The bandwidth capacity of the NAD 130 is used to route data by adhering to the maximum capacity supported by the access link or line and the service tier assigned to the home subscriber 140. In the home environment 140, the data services may be provided by telephone companies, cable provider and/or satellite service providers. Such data service providers may provide data transferred from/to the Internet including over the top video, data transferred from intermediate cache devices at service providers and content provider data centers including data transferred from network-based cache devices.

The NAD 130 communicates with each home device 142, 144, or other home devices not shown but supported by the NAD 130. In one example, the NAD 130 performs polling of each device to determine a maximum bandwidth throughput required by the device and/or by applications hosted by the device. The polling may be performed periodically and the current bandwidth usage at any given time may be recorded and stored in a polling data file which identifies one or more pieces of information not limited to the time, date, device identification, applications currently operating and the amount of bandwidth utilized at the time of polling. The polling procedure may be performed over a particular time window, such as 10 seconds, 1 minute, 2 minutes, etc., to ensure accurate polling data.

The collection of data capacity throughput is performed by a software application programming interface (API) installed on the home devices 142 and 144 and the NAD 130. The application may be provided by the NAD vendor to be installed on each device (e.g., distributed through a NAD-communicator application). Once installed on a home computing device, the communicator application is responsible for collecting the device's application usage data, such as bandwidth usage requirements, actual usage data from polling operations, etc., and advertising the discovered bandwidth requirements to the NAD 130 and/or other network management devices upstream (e.g., DSLAM 124, passive optical network (PON) management devices, central office devices, etc.).

The polling interval is configurable on the NAD 130 (e.g., every 15 min). The NAD 130 maintains a record of the hosts (devices) and application-per-host maximum bandwidth throughput requirements for each device and/or application. The NAD 130 may offer a user display to the user of one or more of the home computing devices 142 and 144. For example, the NAD 130 may display a GUI display including an input bandwidth capacity (upstream/downstream) as provided by a network service provider. The GUI display may also include a home demand requirement estimate based on device/application throughput requirements. Such a configuration may be offered to end users of an Internet protocol television (IPTV) service and/or a high-speed Internet access (HSIA) service offered as ‘data services’ available in a home residential configuration.

The home location 140 may have a predetermined Internet data capacity plan(s). For example, a plan of 10/5 Mbps with 10 Mbps downstream and 5 Mbps upstream. The user may be able to view this exact bandwidth usage information on the graphical user interface (GUI). For example, the traffic application GUI may provide: “Total Downstream Access Rate=10 Mbps, Total upstream Access Rate=5 Mbps The statement. The GUI display may also include a home demand requirement estimate based on a device/application throughput requirement. For example, the device requirements at one particular time may be illustrated as: a. Device <ID-1>: iPhone, i. Movie Watch App=2/1 Mbps, ii. YouTube App=0.2/0.1 Mbps, iii. Etc., b. Device <ID-2>: Tablet, i. App-1=4/2 Mbps, ii. App-2=0.5/0.4 Mbps, iii. Etc., c. Device <ID-3>: STB, i. Microsoft IPTV Client: 6/1 Mbps, d. Etc. The resulting “Total Home Requirement”=12/5 Mbps. Each of the home devices will communicate these specific BW requirements to the home gateway or NAD 130 via a known protocol.

One approach to calculating a good faith BW estimate may be to calculate an average BW usage per application. For instance, if one device has three application operating at a given time, the total BW needed may be estimated based on an amount of BW used by the types of applications or an average BW usage by that device over a particular time interval. This provides a procedure to estimate BW usage without monitoring each application's BW usage.

FIG. 1 illustrates the network access device (NAD) 130 connected to a digital subscriber line access multiplexer (DSLAM) representing the access link (line) to a wide area network (WAN) and/or the Internet. The maximum data throughput allotted to a particular data service supported by this access link may be determined by the access type/technology and/or bandwidth limit for data services set by the network service provider. The bandwidth cap or limit may be set during the provisioning of the subscriber NAD 130 during an initial setup operation or subsequent maintenance procedure.

As illustrated in FIG. 1, connectivity (e.g., local area network (LAN) or WIFI connectivity) may be established between the NAD 130 and the corresponding home computing devices 142 and/or 144. A software-based application installed both on the NAD 130 and the home devices 142/144 may permit the NAD 130 to poll each of the home-based computing devices at specified time intervals. The polled data may be collected periodically and stored in corresponding polling data files to reflect the network characteristics of the home devices 142/144. For example, the polling may include collecting the overall bandwidth throughput requirements of each device being polled at specified time intervals.

The NAD 130 may be configured to permit the subscriber operating a home device 142/144 to open a NAD configuration portal to observe both the actual bandwidth and the requested bandwidth via a display interface. The observed bandwidth usage may be based on the activity of one or more home devices, currently or previously operation applications. The data displayed by the application may be based on current and previous time intervals of bandwidth usage. The service provider may be able to offer additional bandwidth by providing an access point to a current operating support systems (OSS) self-service portal in which the subscriber has the capability to request and purchase additional bandwidth capacity. A data flow exchange between the home NAD 130 and the network service provider's OSS provisioning/billing systems may be required to request and receive additional bandwidth.

The OSS may operate with any of the devices on the network, such as the NAD 130. When determining if more bandwidth is needed and requesting more bandwidth, various features operating on the user's home network devices or NAD 130 may be used. For example, the user home network devices 142 and 144 (CPE) may provide a preconfigured external URL representing the service provider OSS/BSS portal system. The GUI display will direct the user via an Internet browser URL link. The “CPE display” may be within a browser automatically. In operation, the user may simply log onto the application from within a browser. Next, the user may access the OSS/BSS portal from the service provider 122 and request more BW. This may be an automated or manual process, however the URL is accessed from the service provider's web site and the CPE may not have knowledge about the URL. The communication is maintained between any device at home 140 running the Internet browser to an external URL that is the actual service provider's OSS system portal, and the communication is via the Internet.

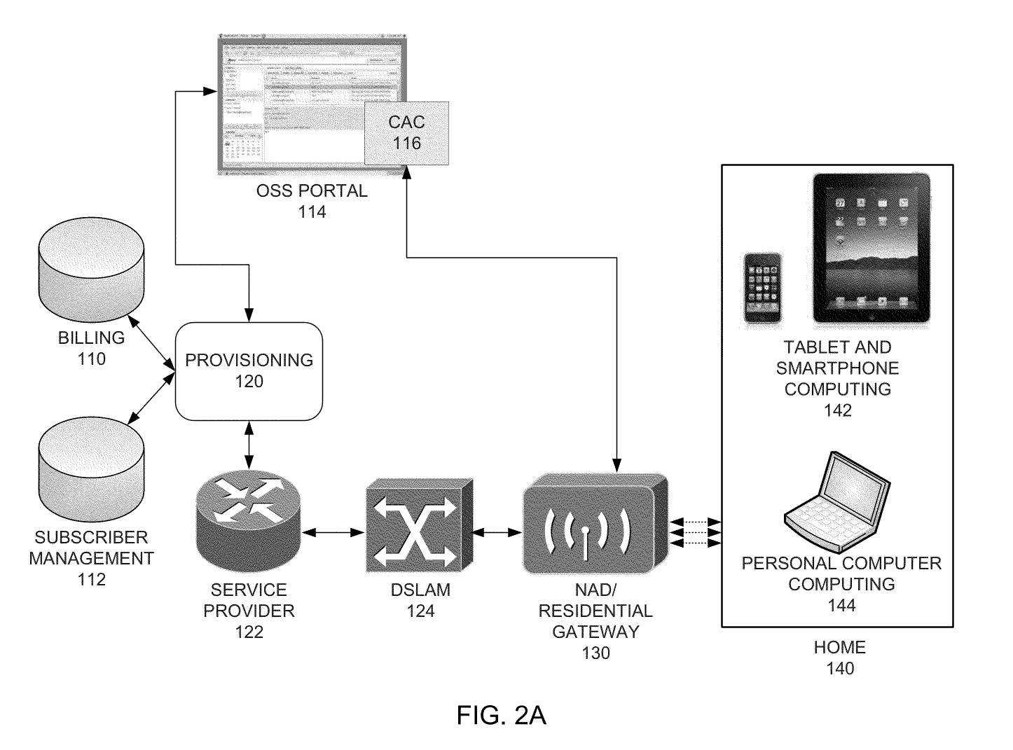

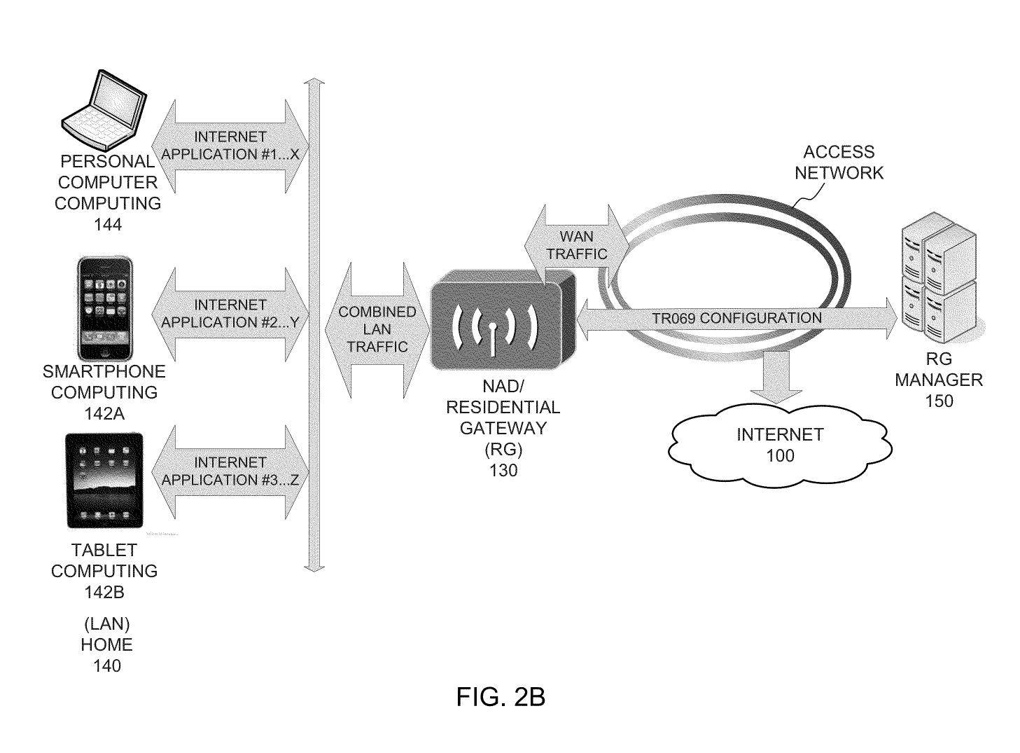

FIG. 2A illustrates a detailed network configuration of the data flow between the NAD 130 and a service provider according to example embodiments. The OSS ordering and capacity management system may apply a validation (connection admission control function) to determine whether the access line can support the additional capacity requested or needed by the user.

The user may analyze the provisioned bandwidth capacity allocated to the user's NAD 130 against the actual home bandwidth requirements at any particular moment. The bandwidth requirement may not be the actual bandwidth being consumed by the user but is instead an aggregate bandwidth required by the applications being operated by the various different devices. The bandwidth required may be based on an estimated level needed for the user to have a satisfactory experience given the current application/device usage requirements.

In order to provide network bandwidth ‘capacity adjustment’ options, the use may be able to experience any one of a plurality of different bandwidth modification options. For example, the user may be able to purchase additional bandwidth capacity on a temporary basis to accommodate current usage requirements without experiencing a lull in near-term bandwidth availability for one or more devices/applications operating on the user's home network. Also, the user may be able to request an upgrade of a data service speed-tier level currently being offered to the user's NAD 130. The user may be made aware of any technical limitations on the user's ability to receive additional bandwidth (e.g., home limitations, line limitations, network service provider offering limitations, etc.) and actual bandwidth being requested by the home devices.

The service provider may be able to determine whether or not the data service-tier assigned to the user can satisfy the actual bandwidth requirements via information logged by the NAD 130 during the polling operations. When the actual bandwidth requirements are not satisfied, the service provider may be allowed to upsell higher data service tiers to the customers.

In operation, the NAD 130 may be offering Internet connectivity to the home network 140 and its respective computing devices 142 and 144. The initial bandwidth throughput rate may be equal to a maximum allowed bandwidth rate available to the customer based on his or her service tier subscription. The NAD 130 may begin polling the home network devices 142 and 144 to capture and store various bandwidth rate operating conditions of the devices and their respective applications over a fixed interval. For example, peak bandwidth usage over the fixed interval, minimum bandwidth usage over the fixed interval, peak bandwidth usage among a plurality of applications executed by one or more of the devices on the network. Upon determining that additional bandwidth is needed, the NAD 130 may initiate a request for additional bandwidth to a connection admission control function (CAC) 116 of an OSS portal 114, which is currently tracking user bandwidth usage and requirements. The CAC 116 may allow a service profile adjustment by deciding to increase the current bandwidth allocation to the home network, or may instead deny any changes to the current bandwidth usage.

The user may not be capable of obtaining additional bandwidth. For example, with xDSL and without pair bonding, if the user requests to increase downstream bandwidth to “50 Mbps”, the user will not be able to obtain such BW requirements due to limited hardware capabilities. In one example, a user may be attempting to watch multiple HD movies from 3 different home network devices at the same time. The NAD 130 may poll the various different home devices on a regular basis to determine the actual BW shortage at any given time and report this information to the service provider 122 and the user devices 142 and 144, etc.

If the CAC 116 determines that a current bandwidth level of the subscriber or end user should be increased, a message may be sent to a provisioning module 120 to notify the service provider 122 to increase the current bandwidth allocation level. The provisioning module 120 may notify a billing database record 110 and/or a subscriber management database 112 to update a customer record(s). For example, a different bill may be created to reflect the increase in bandwidth requirements and a different subscriber service record may be created to reflect the change in service. A corresponding quality of service policy may be created by the provisioning module 120 and pushed to the service provider 122 to initiate the changes to the subscriber's bandwidth service tier level.

Home subscribers may view the current operating condition information from a graphical user interface (GUI) application installed on the NAD 130 and/or the home devices 142 and 144. The interface allows a visual interface for the user to view the bandwidth usage information of the NAD 130. A capability/implementation installed within the NAD 130 displays the incoming data service capacity of the NAD 130 and measures the incoming data capacity against the data capacity demanded by the home and organized by device/application.

FIG. 2B illustrates a data bandwidth computation protocol configuration being operated in accordance with an example network configuration according to example embodiments. Referring to FIG. 2B, like elements refer to like components in other drawings. The NAD 130 may provide various different devices with Internet connectivity (e.g., personal computing device 144, smartphone computing device 142A, tablet computing device 142B, etc.). The NAD 130 may be configured to measure current and past bandwidth utilization of any one or more of the devices operating on the home network 140.

According to example embodiments the data bandwidth computation protocol used on the RG/NAD 130 may provide a local area network (LAN) operating on the home network 140. Each of the various devices operating on the LAN (e.g. 144, 142A, 142B) may be presently operating corresponding applications #1, #2 and #3, respectively, which are utilizing network bandwidth to connect to the Internet (e.g., streaming video applications, file downloading applications, etc.). The combined LAN traffic may be identified by the RG/NAD 130. The RG manager 150 may establish a TR-069 based configuration across the access network to the RG/NAD 130 via a WAN port linked to the network access side of the RG/NAD 130. In operation, once a communication session has been established between the RG manager 150 and the RG/NAD 130, the MAC/IP filter may be applied to filter data and corresponding data packets. The number of packets may be counted and/or the size of each of the packets may be determined and logged in a data filter file. The bandwidth usage for each device and/or device application may then be identified and stored in the data filter file as well. The results of the bandwidth calculations may be displayed at a GUI on the RG/NAD 130. The results may also be shared with the RG manager 150.

According to example embodiments, the bandwidth measuring procedure may provide tracking the real-time bandwidth usage of any of the individual devices of the home network 140 that are in communication with the RG/NAD 130. Measuring bandwidth utilization may, in turn, provide the capability to limit bandwidth allocation for a particular device, enable\disable a device based on bandwidth usage, analyze bandwidth usage patterns and estimate the future bandwidth requirements of the RG/NAD 130. Also, the bandwidth usage patterns may be identified and provided to service providers and allow service providers to configure a bandwidth measuring mechanism using a communication protocol, such as technical report number 069 (TR-069), which is a protocol created by a Broadband Forum technical specification based on a WAN management protocol (CWMP). TR-069 defines an application layer protocol for remote management of end-user devices.

The bandwidth monitoring procedure could be enabled for every device that is active on the RG/NAD 130. The configuration is implemented as a service on the RG/NAD 130. In operation, the application may periodically collect the number and/or sizes of IP packets that are sent to and from a network device (142A, 142B, 144, etc.). In this example, filters may be applied (MAC and IP) for a LAN to WAN and WAN to LAN traffic for a given device. The periodicity and enabling of data collection may be performed via a GUI of the RG/NAD 130, or remotely via the TR-069 protocol. The residential gateway will identify the active home device(s) connected to the RG/NAD 130 for bandwidth measurement purposes. The service will count the number of IP packets and their size in each direction and calculate the average bandwidth usage. The bandwidth usage can be displayed on the RG/NAD 130 graphical user interface (GUI) and/or be sent as a notification to a user's e-mail or instant messaging account to limit the amount of usage of the devices consuming the most bandwidth. A user can restrict the number of smartphones, computers, tablets, etc., connected to the RG/NAD 130 and restrict the use of bandwidth hogging applications operating on those Internet-enabled devices.

The RG/NAD 130 will have a bandwidth consumption measuring application service that can be enabled locally via the RG/NAD 130 GUI and/or remotely via the TR-069 protocol from a residential gateway management system. Once enabled, the monitoring service will periodically collect the number of IP packets from/to a given device being monitored. The application will collect LAN to WAN packets for the upstream traffic. For downstream traffic, the application will collect WAN to LAN packets that have been transmitted or received. The default data collection period may be set to 15 minutes, which may be configurable based on administrative and/or user preferences.

A media access control (MAC) filter and/or an IP packet filter may be set with a source address as the MAC device address of the monitored network device. The MAC filter is applied to the outgoing traffic of a WAN port of RG/NAD 130. Another filter may be applied to the WAN port on the outgoing traffic for unicast/multicast IP packets destined to be transmitted from the RG/NAD 130. Use of the MAC filter may be more accurate than the IP filter as a MAC filter uniquely identifies the device and not a shared IP address. This allows an accurate calculation of upstream traffic. Another MAC filter may be applied to a LAN side port(s) of the residential gateways (RGs) with a MAC destination as the selected device MAC address. A filter may be applied to collect unicast/multicast IP packets being sent towards/from network devices in order to measure downstream/upstream traffic.

The application may then calculate the average data bandwidth per periodic interval (e.g., 1 minute, 10 minutes, 15 minutes, etc.) being used by each device by using the bandwidth estimation formula=(number of filtered IP packet bytes routed out to Internet/the periodicity interval). For the upstream packets, only routed packets to the WAN ports should be considered and not the bridged packets to other network devices. In the case of packets that are routed within supplemental networks behind the LAN ports of the RG/NAD 130, the IP packets should not be considered for bandwidth consumption.

The computed value of bandwidth usage is stored in a database or memory in the RG/NAD 130. Next, another periodic time interval's average BW usage is calculated. At the end of 24 hours of periodic interval measurements, a daily average is computed. A notification is sent to the user's specified e-mail address or communication medium of choice to inform him of her of the devices on the LAN network using the maximum bandwidth in a given day. As the user compares this information to the bandwidth profile subscription associated with the user's data service account, the user can then make the decision to change the profile if the network device(s) usage demands more or even less bandwidth subscription services. However, such a decision can be made automatically without user intervention based on a predefined bandwidth usage threshold.

The user may also set limits on each network device by enabling metering of downstream and upstream traffic based on the retrieved data. The configuration used to set up a remote bandwidth calculation application may be achieved via the TR-069 protocol from the RG manager 150, which can also specify the parameters that can be sent to the RG manager 150 for administrative services to evaluate the bandwidth profile allotted for a particular subscriber. The parameters can be added in the data model for a particular RG/NAD 130. The parameters may include IP unicast traffic per device, IP multicast traffic per device, bandwidth usage per day, etc. RG manager 150 may also configure bandwidth limits for a particular device via the TR-069 communication protocol. The residential gateway's GUI may allow enabling/disabling of bandwidth calculation for all connected devices collectively and/or individually. The GUI can display the bandwidth usage per device when requested. The user can limit the bandwidth usage for a particular device via the GUI.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

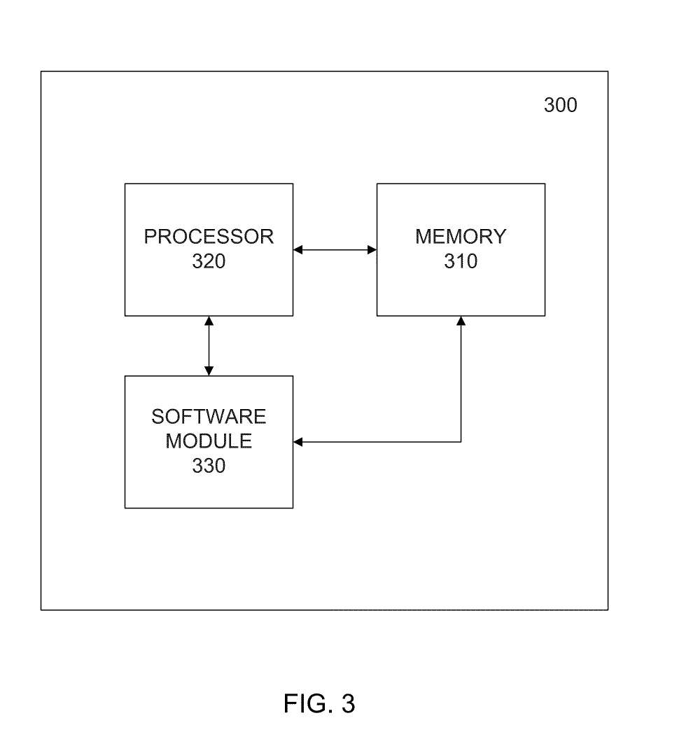

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 3 illustrates an example network element 300, which may represent any of the above-described network components of FIGS. 1 and 2A and 2B.

As illustrated in FIG. 3, a memory 310 and a processor 320 may be discrete components of the network entity 300 that are used to execute an application or set of operations. The application may be coded in software in a computer language understood by the processor 320, and stored in a computer readable medium, such as, the memory 310. The computer readable medium may be a non-transitory computer readable medium that includes tangible hardware components in addition to software stored in memory. Furthermore, a software module 330 may be another discrete entity that is part of the network entity 300, and which contains software instructions that may be executed by the processor 320. In addition to the above noted components of the network entity 300, the network entity 300 may also have a transmitter and receiver pair configured to receive and transmit communication signals (not shown).

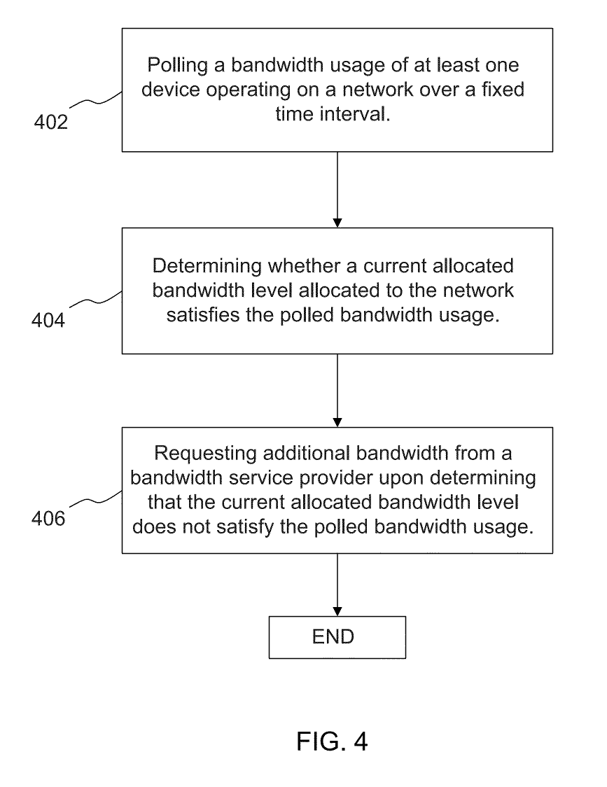

One example method of operation may include a method of FIG. 4. The method of FIG. 4 may include polling a bandwidth usage of at least one device operating on a network over a fixed time interval 402, and determining whether a current allocated bandwidth level allocated to the network satisfies the polled bandwidth usage 404. The method may also include requesting additional bandwidth from a bandwidth service provider upon determining that the current allocated bandwidth level does not satisfy the polled bandwidth usage 406.

While preferred embodiments of the present disclosure have been described, it is to be understood that the embodiments described are illustrative only and the scope of the embodiments is to be defined solely by the appended claims when considered with a full range of equivalents and modifications (e.g., protocols, hardware devices, software platforms etc.) thereto.

What is claimed is:

1. A method, comprising:
polling a bandwidth usage of at least one device operating on a network over a fixed time interval by an application installed on at least one of a network access device and the at least one device;
determining whether a current allocated bandwidth level allocated to the network satisfies the polled bandwidth usage; and
requesting additional bandwidth from a bandwidth service provider upon determining that the current allocated bandwidth level does not satisfy the polled bandwidth usage.

2. The method of claim 1, wherein the bandwidth usage is polled for the at least one device and at least one application currently operating on the at least one device.

3. The method of claim 2, wherein the bandwidth usage is polled for a plurality of applications being operated by the at least one device.

4. The method of claim 3, further comprising:
determining at least one application operated by the at least one device requires additional bandwidth not presently allocated to the network; and
requesting an increase in the bandwidth level of the network to accommodate bandwidth requirements of the at least one device based on the at least one application requiring additional bandwidth.

5. The method of claim 4, further comprising:
transferring a notification to the at least one device requesting permission to increase the current service tier bandwidth level to a next service tier bandwidth level; and
receiving a confirmation from the at least one device to increase the current service tier bandwidth level.

6. The method of claim 5, further comprising:
increasing the current service tier bandwidth level of the network to the next service tier bandwidth level; and
storing a record of the service tier bandwidth level in a user account associated with the network.

7. The method of claim 1, further comprising:
applying at least one of a media access control (MAC) filter and an Internet protocol (IP) filter to filter data packets originating from the at least one device and data packets received at the at least one device; and
calculating a number of data packets identified by the at least one applied filter; and
estimating an average bandwidth usage of the at least one device based on the at least one calculated number of data packets.

8. An apparatus, comprising:
a processor configured to:
poll a bandwidth usage of at least one device operating on a network over a fixed time interval by an application installed on at least one of a network access device and the at least one device; and
determine whether a current allocated bandwidth level allocated to the network satisfies the polled bandwidth usage; and
a transmitter configured to transmit a request for additional bandwidth from a bandwidth service provider upon determining that the current allocated bandwidth level does not satisfy the polled bandwidth usage.

9. The apparatus of claim 8, wherein the bandwidth usage is polled for the at least one device and at least one application currently operating on the at least one device.

10. The apparatus of claim 9, wherein the bandwidth usage is polled for a plurality of applications being operated by the at least one device.

11. The apparatus of claim 10, wherein the processor is further configured to determine at least one application operated by the at least one device requires additional bandwidth not presently allocated to the network, and the transmitter is further configured to transmit a request for an increase in the bandwidth level of the network to accommodate bandwidth requirements of the at least one device based on the at least one application requiring additional bandwidth.

12. The apparatus of claim 11, wherein the transmitter is further configured to transfer a notification to the at least one device requesting permission to increase the current service tier bandwidth level to a next service tier bandwidth level, and receive a confirmation from the at least one device to increase the current service tier bandwidth level.

13. The apparatus of claim 12, wherein the processor is further configured to increase the current service tier bandwidth level of the network to the next service tier bandwidth level, and the memory is configured to store a record of the service tier bandwidth level in a user account associated with the network.

14. The apparatus of claim 8, wherein the processor is further configured to
apply at least one of a media access control (MAC) filter and an Internet protocol (IP) filter to filter data packets originating from the at least one device and data packets received at the at least one device,
calculate a number of data packets identified by the at least one applied filter, and
estimate an average bandwidth usage of the at least one device based on the at least one calculated number of data packets.

15. A non-transitory computer readable medium configured to store instructions that when executed cause a processor to perform:
polling a bandwidth usage of at least one device operating on a network over a fixed time interval by an application installed on at least one of a network access device and the at least one device;
determining whether a current allocated bandwidth level allocated to the network satisfies the polled bandwidth usage; and
requesting additional bandwidth from a bandwidth service provider upon determining that the current allocated bandwidth level does not satisfy the polled bandwidth usage.

16. The non-transitory computer readable storage medium of claim 15, wherein the bandwidth usage is polled for the at least one device and at least one application currently operating on the at least one device.

17. The non-transitory computer readable storage medium of claim 16, wherein the bandwidth usage is polled for a plurality of applications being operated by the at least one device.

18. The non-transitory computer readable storage medium of claim 17, wherein the processor is further configured to perform:
determining at least one application operated by the at least one device requires additional bandwidth not presently allocated to the network; and
requesting an increase in the bandwidth level of the network to accommodate bandwidth requirements of the at least one device based on the at least one application requiring additional bandwidth.

19. The non-transitory computer readable storage medium of claim 18, wherein the processor is further configured to perform:
transferring a notification to the at least one device requesting permission to increase the current service tier bandwidth level to a next service tier bandwidth level; and
receiving a confirmation from the at least one device to increase the current service tier bandwidth level.

20. The non-transitory computer readable storage medium of claim 19, wherein the processor is further configured to perform:
increasing the current service tier bandwidth level of the network to the next service tier bandwidth level; and
storing a record of the service tier bandwidth level in a user account associated with the network.
